(19) United States
(12) Patent Application Publication
(10) Pub. No.: US 2012/0123957 A1
(43) Pub. Date: May 17, 2012

(54) Computerized System and Methods for Matching a Project and at Least One Applicant

(76) Inventor: Sean Coleman, (US)

(21) Appl. No.: 12/945,499

(22) Filed: Nov. 12, 2010

(51) Int. Cl. G06Q 10/00

(52) U.S. Cl. 705/321

(57) ABSTRACT

A computerized system or method having a project management interface for an employer to describe the project, an applicant interface that allows an applicant to key in his/her profile, and a system module that, based on certain characteristics of the matches previously accepted by any employer, assigns a score for each of the characteristic to the applicant, gives the score a weight, and uses the sum of the weighed scores to determine whether the applicant profile will be displayed to the employer. The score for a characteristic may be the frequency of a value of the characteristic. The system module may use correlations of keywords between the applicant characteristics and the project characteristics. The system module may also be implemented to provide bonus scores for applicants that have certain properties.

### BACKGROUND OF THE INVENTION

1. Field of the Invention

This invention generally relates to matching a project with multiple applicants, or alternatively matching an applicant with multiple projects, by strategically analyzing or manipulating the correlations between common characteristics of a project and an applicant to exclude unwanted candidates.

2. Description of Related Art

Traditionally, a hiring employer advertises a job opening with a job description, collects resumes, and reads through all the resumes to find potentially qualified employees. More recently, online job matching services use search criteria provided by an employer to generate a list of applicants that meet all or some of those criteria. With the increase in the number of users of the job matching services, the system inevitably has to provide some functions smart enough to help the employers to get sufficient but not too many applicants by using the correlation between the applicant profiles and the job description. Using the correlation between the profiles by comparing each characteristic, however, may not always generate the best result for the employer. For example, some characteristics may generally be more important than others. Or some employers may have different preferences for certain characteristics than other employers may have. Some job matching services have been implemented to resolve these issues.

So as to reduce the complexity and length of the Detailed Description, and to fully establish the state of the art in certain areas of technology, Applicant herein expressly incorporates by reference all of the following materials identified in each numbered paragraph below.

U.S. Pat. No. 7,720,791 (2010) to Hyder et al. describes a system and method for matching projects or employment opportunities with applicants. The system, in addition to matching a project with applicants based on correlations between project characteristics and applicant characteristics, narrows search results based on the applicant's or employer's search activity and personalized preferences. The employer's personal preferences may come from the interactive queries between the employer and the system and/or the employer's interest history.

U.S. Pat. No. 6,567,784 (2003) to Bukow describes a system and methods of matching projects and applicants using a two-stage matching process. The first stage uses mandatory, or binary, characteristics to reduce the number of applicants. For example, only applicants located within 50 miles of the office are considered. The second stage quantitatively evaluates other characteristics. A value between 0% and 100% is assigned to a characteristic. For instance, the value of an applicant's hourly rate is determined by how close his/her hourly rate is to that of the project. Therefore, an applicant with the hourly rate closest to the rate of the project is assigned 100%. In addition to the two-stage matching process, feedback about applicant's performance can also be a factor affecting the applicant's rating in the future.

Both of the patents mentioned above disclose online or computerized systems or methods of matching a project with applicants based on the characteristics or the history of the project and the applicants. These systems improve their matching results from the history of the specific employer or applicant, including the employer's assigned priority for each characteristic and/or the applicant's past performance. However, a new user, either an employer or an applicant, cannot benefit from the “experience” of the systems because of the lack of the user's history.

This issue might have been considered in the '791 patent, in which the system may determine the relevance of applicant's characteristic to the project's based on the “popularity” of this characteristic. The popularity is derived from other employers' subjective preferences of each characteristic, rather than their overall ratings of the matched applicants. However, the popularities of individual characteristics, put together, might not indicate that the matches made are satisfying. For example, an employer might think that the applicant's major in college is the key to his decision of hiring, but actually he very often prefers the applicants with relevant work experience to those whose majors fall exactly into his criteria. In short, the existing job matching systems are not smart enough to help the employers (and/or applicants) to find the “best” matches without burdening them with extra inquiries or setting the matching criteria specific enough.

Applicant believes that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant will amend the specification to expressly recite the essential material that is incorporated by reference as allowed by the applicable rules.

### BRIEF SUMMARY OF THE INVENTION

The present invention provides among other things a computerized system, method, and software to match a project with one or more applicants, or to match an applicant with multiple projects. It is the object of this invention to match the most qualified and overall best applicants to the project based on what the system has learned from previously accepted matches.

The above object may be achieved using a computerized system, method, or software which includes a project management interface for an employer to describe the project, an applicant interface that allows an applicant to key in his/her profile, and a system module that, based on certain characteristics of the matches previously accepted by any employer, assigns a score for each of the characteristic to the applicant, gives the score a weight, and uses the sum of the weighed scores to determine whether the applicant profile will be displayed to the employer.

In this invention, the subset of the characteristics, called the “Historical Set,” is predetermined based on how the characteristics affect the employer's decision to accept or reject a match. For example, if employers for web design projects only accept the applicants whose majors are either computer science or photography, this characteristic is highly correlated to the success of the matching. So, only the characteristics that more likely have affected the employers' acceptance/denial are selected into the Historical Set.

In one embodiment, the score is the frequency of a value of the characteristic. The system (method and/or software) stores an accepted match in a database, and recalculates the frequency of each characteristic of the matching, and determines whether this characteristic should be included in the set of the predetermined characteristic. In another embodiment, “gates” are used to exclude the applicants whose profiles fail to meet certain criteria in an earlier stage to improve system efficiency. For example, the applicant is currently not seeking any job, or the project requires applicants in a certain area. Gates are also characteristics in the applicant profile.

In some embodiments, an applicant may be given some “bonus scores” when the applicant is a frequent user of this system, or when the applicant has maintained a high average rating from previous employers, etc. These properties of the applicant profile are collectively called the Unassociated Set. Moreover, in another embodiment, characteristics may be assigned scores based on how the keywords in the characteristics of an applicant profile match or correlate to those in the project. Some implementations may assign the keyword scores only to characteristics that are not within the Historical Set, while others use all of the characteristics. The characteristics to be used in keyword matching are called the Keyword Set.

In addition, the weight of each characteristic can be determined by the system or by the employer. Because the characteristics in the Historical Set are considered more useful in determining the ranking, these characteristics are preferably given more weight than other characteristics. Persons with relevant skills in the arts would know that the same system, method, or software may also be implemented to match an applicant with multiple projects.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographers if desired. The inventor expressly elects, as his own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶6. Thus, the use of the words “function,” “means” or “step” in the Detailed Description or Description of the Drawings or claims is not intended to somehow indicate a desire to invoke the special provisions of 35 U.S.C. §112, ¶6, to define the invention. To the contrary, if the provisions of 35 U.S.C. §112, ¶6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a computerized system that has interfaces for applicants and employers, a system module that matches the applicants with the projects, and one or more databases storing the user inputs and system information.

FIG. 2 is a block diagram of a method of determining a matching score.

FIG. 3 is a block diagram of a method of determining a score of a characteristic in the Historical Set based on the frequency of a value of the characteristic.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

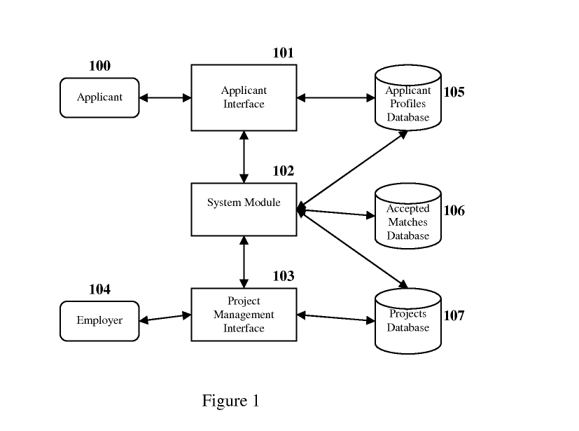

In FIG. 1, the basic system modules, databases, and their interactions are shown. The interfaces for applicants (Applicant Interface, 101) and employers (Project Management Interface, 103) receive the user inputs and save them to the respective databases (Applicant Profiles Database, 105, and Projects Database, 107). A System Module (102) matches the applicants with the project(s) by retrieving profiles from the databases (105-107), receiving commands from the user interface(s) (101 and 103), and updating the databases (105-107) when an employer or an applicant responds to a match, either by accepting it or providing feedback. The profiles and data can be stored in one or multiple databases, depending on the implementation of the system.

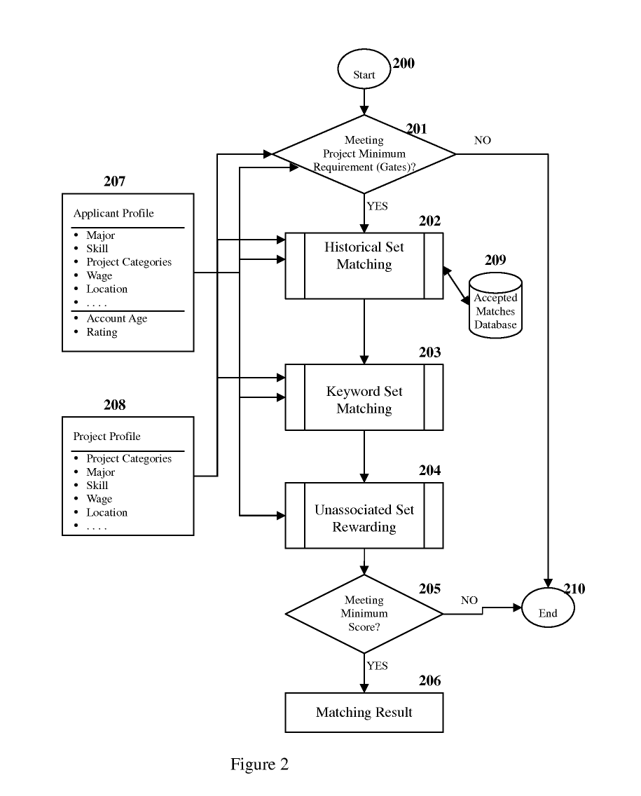

FIG. 2 depicts an embodiment of the processes in evaluating whether an applicant should be included in the matching result. Before evaluating the correlations between the applicant and the project, the applicant profile must pass several “Gates” (201) in which some characteristics of the applicant are used to exclude the applicant from further consideration. After applying the gates, the matching algorithm comprises a series of information-associative processes (202-204) through which an applicant's relevancy ranking/valuation to a specified project is determined. This relevancy depends mostly on the profile data—extracted into the discrete data points—provided by both the applicant (in the applicant's profile 207), and by the employer (in the project's profile 208).

Each characteristic has a score value from 0 to 100, based on the worst and best possible values respectively. The best possible applicant-project match for a particular characteristic would be 100 points, and the worst 0 points. Each process has unique logic for determining the points. Additionally, each characteristic may be applied an integral weight that is changeable based on the age of the system, amount of historic data, etc. Each characteristic's point assignment is multiplied by the weight resulting in a weighted score. The total weighted scored of each set is added together. This process is run on every applicant in the system who passes all gates for a project, giving a final compatibility score and essentially a ranking.

An example of how the score and the ranking are determined for an applicant, A, for a web design project is illustrated as below:

### Historical Set Matching (202)

Major: 100 points (weight: 9)=900 weighted score. (Max=900)

Project Categories: 80 points (weight: 6)=480 weighted score. (Max=600)

Weighted Total: 1380 (Max=1500)

### Keyword Set Matching (203)

Major: 60 points (weight: 8)=480 weighted score. (Max=800)

Wage: 87 points (weight: 2)=174 weighted score. (Max=200)

Weighted Total: 654 (Max=1000)

### Unassociated Set Rewarding (204)

Rating: 40 points (weight: 27)=1080 weighted score. (Max=2700)

Weighted Total: 1080 (Max=2700)

### Applicant A's Total: 3014 (Max=5200)

Assuming Applicant B has a final compatibility score of 3100, and Applicant C had a final compatibility score of 2900, the order of matches would be:

### Applicant B (Best Match)

### Applicant A

### Applicant C

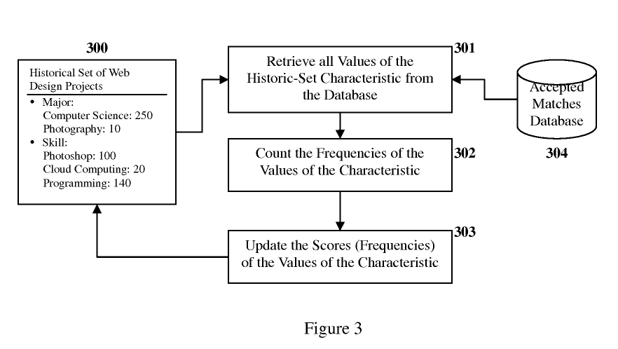

In FIG. 3, the score of a characteristic in the Historical Set (300) is determined based on the frequency of a value of the characteristic in the accepted matches (304). For example, all 300 applicants in the system that have completed a project with Web Design in the past are collected (301). All majors from the 300 applicants are collected and the summed to determine the frequency that each major appears (302). Since 250 of the applicants had Computer Science listed as a major, Computer Science is assigned a score of 250. Since only 10 applicants have Photography listed as a major, the assigned score for the Photography major is 10.

The predetermined scores of Computer Science and Photography are saved back to the Historical Set (303). All applicants in the system will be assigned respective scores for their majors. Each applicant with Computer Science is assigned a score of 250 (for this characteristic) while each applicant with Photography is assigned a score of 10 (for this characteristic) until next accepted match is saved.

I claim:

1. A computerized system of matching a project with at least one applicant, comprising:
a project management interface, configured to:
receive a value of at least one characteristic of the project; and
store the value of the characteristic of the project to the database;
an applicant interface, configured to:
receive a value of at least one characteristic of the applicant; and
store the value of the characteristic of the applicant to the database;
a system module, configured to:
assign at least one score of a characteristic to the applicant, wherein the characteristic is within a predetermined set of characteristics and the score is predetermined based on at least one match that has been previously accepted by an employer;
multiply the score by a weight to form a ranking; and
display an applicant profile that has a ranking that meets a predefined minimum ranking value.

2. The system of claim 1 further comprising a second system module, configured to:
store an accepted match to a database of matches that have been previously accepted by an employer;
determine a frequency of the value of the characteristic of the applicant in the database of matches;
create a predetermined set of characteristics based on the frequency; and
assign a score to a characteristic in the predetermined set of characteristics based on the frequency.

3. The system of claim 1 further comprising a third system module, configured to exclude the applicant profile that has a characteristic which fails a minimum requirement of the project.

4. The system of claim 1, wherein the system module is further configured to:
assign at least one bonus score to the applicant based on at least one property of the applicant profile;
multiply the bonus score by a bonus weight to form a product; and
add the product to the ranking.

5. The system of claim 1, wherein the system module is further configured to:
assign at least one second score to the applicant based on a level of correlation between a second characteristic of the applicant correlates to the second characteristic of the project;
multiply the second score by a second weight to form a second product; and
add the second product to the ranking.

6. The system of claim 5, wherein the second characteristic is within the predetermined set of characteristics.

7. The system of claim 1, wherein the project management interface is further configured to receive a feedback.

8. A method of matching a project with a least one applicant by computer comprising the acts of:
receiving, by a computer, a user input value of at least one characteristic of the project;
storing, by the computer, the value of the characteristic of the project to a database;
receiving, by the computer, a second user input value of at least one characteristic of the applicant;
storing, by the computer, the value of the characteristic of the applicant to the database;
assigning, by the computer, at least one score of a characteristic to the applicant, wherein the characteristic is within a predetermined set of characteristics and the score is predetermined based on at least one match that has been previously accepted by an employer;
multiplying, by the computer, the score by a weight to form a ranking; and
displaying, by the computer, an applicant profile that has a ranking that meets a predefined minimum ranking value.

9. The method of claim 8 further comprising:
storing an accepted match to a database of matches that have been previously accepted by an employer;
determining a frequency of the value of the characteristic of the applicant in the database of matches;
creating a predetermined set of characteristics based on the frequency; and
assigning a score to a characteristic in the predetermined set of characteristics based on the frequency.

10. The method of claim 8 further comprising excluding an applicant profile that has a characteristic which fails a minimum requirement of the project.

11. The method of claim 8 further comprising:
assigning at least one bonus score to the applicant based on at least one property of the applicant profile;
multiplying the bonus score by a bonus weight to form a product; and
adding the product to the ranking.

12. The method of claim 8 further comprising:
assigning at least one second score to the applicant based on a level of correlation between a second characteristic of the applicant and the second characteristic of the project;
multiplying the second score by a second weight to form a second product; and
adding the second product to the ranking.

13. The method of claim 12, wherein the second characteristic is within the predetermined set of characteristics.

14. The method of claim 8, wherein the project management interface is further configured to receive a feedback.

15. A computer readable medium having control logic stored therein that, when executed by a computer, is configured to:
receive a value of at least one characteristic of the project;
store the value of the characteristic of the project to the database;
receive a value of at least one characteristic of the applicant;
store the value of the characteristic of the applicant to the database;
assign at least one score of a characteristic to the applicant, wherein the characteristic is within a predetermined set of characteristics and the score is predetermined based on at least one match that has been previously accepted by an employer;
multiply the score by a weight to form a ranking; and
display an applicant profile that has a ranking that meets a predefined minimum ranking value.

16. The computer readable medium of claim 15 further configured to:
store an accepted match to a database of matches that have been previously accepted by an employer;
determine a frequency of the value of the characteristic of the applicant in the database of matches;
create a predetermined set of characteristics based on the frequency; and
assign a score to a characteristic in the predetermined set of characteristics based on the frequency.

17. The computer readable medium of claim 15 further configured to exclude the applicant profile that has a characteristic which fails a minimum requirement of the project.

18. The computer readable medium of claim 15 further configured to:
assign at least one bonus score to the applicant based on at least one property of the applicant profile;
multiply the bonus score by a bonus weight to form a product; and
add the product to the ranking.

19. The computer readable medium of claim 15 further configured to:
assign at least one second score to the applicant based on a level of correlation between a second characteristic of the applicant correlates to the second characteristic of the project;
multiply the second score by a second weight to form a second product; and
add the second product to the ranking.

20. The computer readable medium of claim 19, wherein the second characteristic is within the predetermined set of characteristics.
